(19) United States
(12) Patent Application Publication
(10) Pub. No.: US 2009/0210206 A1
(43) Pub. Date: Aug. 20, 2009

(54) Method and for wide track erasure in a hard disk drive

(75) Inventors: Haesung Kwon, San Jose, CA (US); Hyung Jai Lee, Cupertino, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 12/070,141

(22) Filed: Feb. 15, 2008

(51) Int. Cl. G06G 7/50; G06G 7/62

(52) U.S. Cl. 703/9; 703/13

(57) ABSTRACT

A method and its implementation as a program system are disclosed herein for generating an air flow report based upon a cellular model of the air flow of a hard disk drive including a parameterized component approximated by a component parameter list and a map of the partitioned regions of the hard disk drive. The air flow report is generated based upon the cellular model and a partition/region map. The partition/region map lumps the simulation domain into a small number of regions and then calculates the fluxes across boundaries of the regions. These fluxes accumulate the results of many individual cells, averaging out small variations caused by rounding and/or the convergence properties of the specific cellular approach used. A simulation figure of merit is calculated from the air flow report that further refines the accuracy, effectively removing even more noise.

### TECHNICAL FIELD

This invention relates to reduction of numerical noise in simulation reports of air flow within for a hard disk drive and to use of this noise reduction to optimize the performance of air flow simulations for hard disk drives.

### BACKGROUND OF THE INVENTION

The quest for ever greater performance is leading designers to consider air flow effects that can consume huge computer resources just to numerically simulate one of many alternatives to the components for a new hard disk drive. These resources are required because contemporary mechanisms for solving fluid dynamic systems frequently divide up the domain of air flow into piecewise approximations over a collection of cells that cover the domain. Fluid dynamic systems may be formulated as a system of partial differential equations representing the compliance of the air flow to certain generally observed physical principles. These principles include conservation laws for mass, energy and/or momentum. The partial differential equations are often formulated around assumptions of compressible and/or incompressible fluids as found in continuum mechanics and sometimes around statistical mechanical assumptions that may account for molecular interactions often within the boundary layer of the overall continuum model.

These piecewise approximations are often formulated as finite difference, finite element and/or finite volume approximations. A finite difference of a function ƒ(x) may be represented as ƒ(x+b)−ƒ(x+a) and the quotient [ƒ(x+b)−ƒ(x+a)]/(b−a) in various forms may be used to represent the derivative ƒ′(x), with more complex quotients being used to represent higher derivatives. The cell in these models is a point arranged in a usually uniform grid. This approach has been in continuous development ever since the dawn of calculus and Newtonian physics. While it has a good deal of appeal for its conceptual simplicity, these models have not tended to converge quickly.

The finite element approach emerged in the 1940's and has been the source of some remarkable improvements. This approach often involves a discrete mesh approximating a continuous domain. The cells may be triangular pyramids arranged with more cells where there is greater need for accuracy to cover a three dimensional domain. Finite element models can frequently account for the varying components of domain such as found in hard disk drives.

The finite volume approach tends to represent and evaluate partial differential equations as algebraic equations evaluated on discrete locations in a geometric mesh. Each location accounts for the fluid flow in a volume about itself, hence the phrase finite volume. In this approach volume integrals in the partial differential equations including a divergence term are replaced with surface integrals that are evaluated as fluxes at the surfaces of each finite volume. Conservation occurs by maintaining that the flux entering each volume must equal the flux leaving the volume. This method is well suited for unstructured meshes such as found in hard disk drives.

Most if not all designers of hard disk drives use one or more of these approaches to limit prototype development time and expense to the most likely component candidates and combinations for new hard disk drives. To increase the accuracy of these models, the conventional wisdom is to increase the number of cells being approximated, but to double the points in each of the three standard spatial dimensions increases the number of cells by a factor of eight, slowing the computation of each step of these cellular models. Recent changes indicate that using these approaches will require refining the meshes by a factor of at least 8 in each spatial dimension, causing a simulation that now requires four million points to require over 500 times that many, rendering the simulation that today can be reasonably done on about 32 numeric processors to now require 16,000 processors for anywhere near the same simulation performance. An approach is needed that extends the usefulness of the numeric simulation tools of these designers without requiring such an enormous increase in computing resources.

### SUMMARY OF THE INVENTION

Embodiments of the invention include a method and its implementation as a program system for generating an air flow report based upon a cellular model of the air flow of a hard disk drive including a parameterized component approximated by a component parameter list and a map of the partitioned regions of the hard disk drive. The air flow report is generated based upon the cellular model and a partition/region map. The partition/region map lumps the simulation domain into a small number of regions and then calculates the fluxes across boundaries of the regions. These fluxes accumulate the results of many individual cells, averaging out small variations caused by rounding and/or the convergence properties of the specific cellular approach used. A simulation figure of merit is calculated from the air flow report that further refines the accuracy, effectively removing even more noise.

The parameterized component may include but is not limited to any one or more of the slider, the head gimbal assembly, the head stack assembly, one or more disk dampers, one or more air baffles, one or more air ducts, the disk base, the disk cover and/or the disk pack including the spindle motor rotatably coupled to the disks. The air ducts may include filters that may also be parameterized.

The cellular model may include at least one instance of a finite difference model, a finite element model and/or a finite volume model of at least part of the hard disk drive.

### BRIEF DESCRIPTION OF THE DRAWINGS

FIG. 1A shows an example of a hard disk drive for which a parameterized component is being optimized to account for the effects of air flow. The hard disk drive includes a disk base to which a spindle motor is mounted. The spindle motor is rotatably coupled to at least one disk to create at least one rotating disk surface that generates a wind when rotating. A voice coil motor is pivotably mounted to the disk base and includes at least one actuator arm for moving a head gimbal assembly to position a slider near a track on the rotating disk surface, all of which is affected by the air flow resulting from the configuration of the parameterized component.

FIG. 1B shows some details of the parameterized component of FIG. 1A that may for example include an angle and a length that are to be optimized with regards to the effects of air flow in the hard disk drive.

FIG. 2 shows a map of a cellular model of air flow for the hard disk drive embodiment with the parameterized component. Three partitions of the cellular model produce six regions and the effects with each of the regions is summarized by the air flow across the boundaries of these regions.

FIG. 3 shows an example embodiment of the invention including an analysis system. The analysis system includes a computer accessibly coupled via a bus to a computer readable memory. The computer readable memory includes at least one instance of the cellular model of the air flow for the hard disk drive, a partition/region map of the cellular model, an air flow report generated from the cellular model and the partition/region map and a simulation figure of merit derived from the air flow report. The memory also includes a component parameter list, the previous simulation parameters and the next simulation parameters. The computer is directed by a program system including program steps residing in the memory.

FIG. 4 shows some details of an example of the cellular model of air flow in the hard disk drive and may include at least one of a finite difference model, a finite element model and/or a finite volume model.

FIG. 5A shows some details of the partition/region map of the hard disk drive of FIGS. 2 and 3, where the arrows show the boundaries with air flow across them.

FIG. 5B shows the air flow report assigning numeric strengths to the arrows, indicating the air flow across those boundaries shown in FIG. 5A.

FIG. 6 shows the component parameter list including by way of example, the angle and length of the parameterized component shown in FIGS. 1A and 1B.

And FIG. 7 shows an embodiment of the program system including at least one of generating the air flow report based upon the cellular model and the partition/region map, calculating the simulation figure of merit from the air flow report and/or determining the next simulation parameters from the component parameter list, the simulation figure of merit and the previous simulation parameters.

### DETAILED DESCRIPTION

This invention relates to reduction of numerical noise in simulation reports of air flow within for a hard disk drive and to use of this noise reduction to optimize the performance of air flow simulations for hard disk drives.

Embodiments of the invention include a method and its implementation as a program system for generating an air flow report based upon a cellular model of the air flow of a hard disk drive including a parameterized component approximated by a component parameter list and a map of the partitioned regions of the hard disk drive. The air flow report is generated based upon the cellular model and a partition/region map. The partition/region map lumps the simulation domain into a small number of regions and then calculates the fluxes across boundaries of the regions. These fluxes accumulate the results of many individual cells, averaging out small variations caused by rounding and/or the convergence properties of the specific cellular approach used. A simulation figure of merit is calculated from the air flow report that further refines the accuracy, effectively removing even more noise.

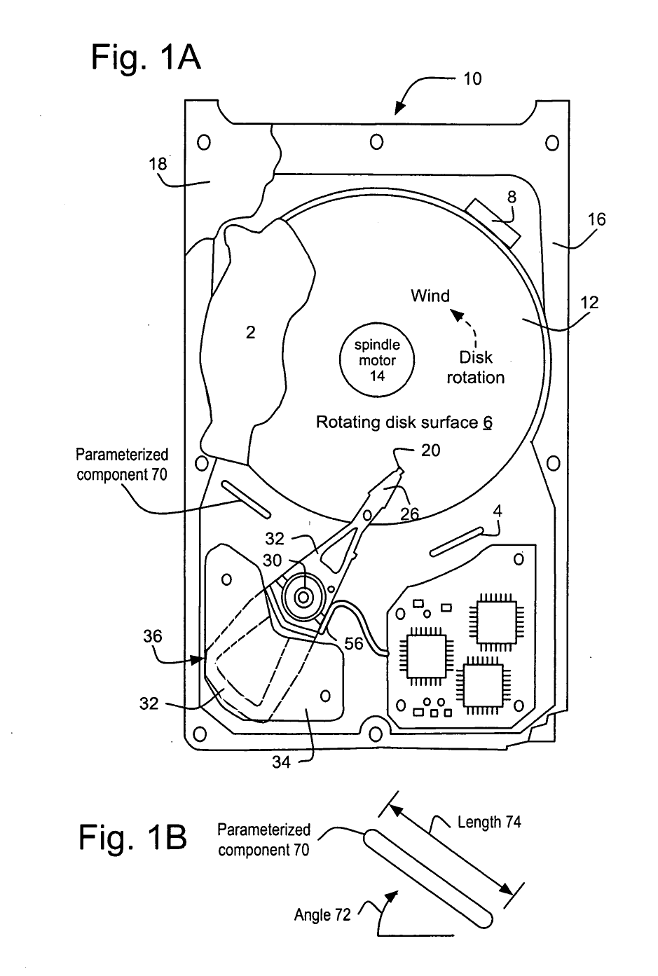

Referring to the drawings more particularly by reference numbers, FIG. 1A shows an example of a hard disk drive 10 for which a parameterized component 70 is being optimized to account for the effects of air flow. The hard disk drive includes a disk base 16 to which a spindle motor 14 is mounted. The spindle motor is rotatably coupled to at least one disk 12 to create at least one rotating disk surface 6 that generates a wind when rotating. A voice coil motor 36 is pivotably mounted to the disk base by an actuator pivot and includes at least one actuator arm for moving a head gimbal assembly 26 to position a slider 20 near a track on the rotating disk surface, all of which is affected by the air flow resulting from the configuration of the parameterized component 70. The hard disk drive preferably includes a head stack assembly 32 including the actuator arm coupling to the head stack assembly, pivoting about the actuator pivot 30 and moving in response to the voice coil 32 and its interaction with a fixed magnet assembly 34. The voice coil motor include the head stack assembly and the fixed magnet assembly. The hard disk drive may include one or more baffles 4 such as the parameterized component. The hard disk drive may also include one or more air ducts 8 that may or may not include filters. A disk cover 18 is mounted upon the disk base to encapsulate all of the shown components except the control circuit, which is usually mounted on the opposite side of the disk base.

The parameterized component 70 may include but is not limited to any one or more of the slider 20, the head gimbal assembly 27, the head stack assembly 32, one or more disk dampers 2, one or more air baffles 8, one or more air ducts 8, the disk base 16, the disk cover 18, and/or a disk pack including the spindle motor 14 rotatably coupled to at least one disk 12.

FIG. 1B shows some details of the parameterized component 70 of FIG. 1A that may for example include an angle 72 and a length 74 that are to be optimized with regards to the effects of air flow in the hard disk drive 10.

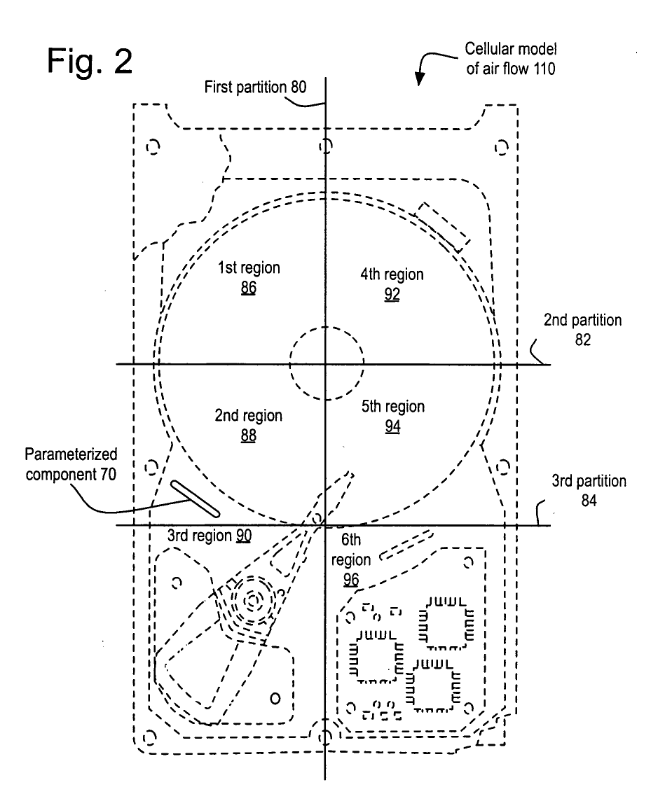

FIG. 2 shows a map of a cellular model of air flow for the hard disk drive 10 embodiment with the parameterized component 70. Three partitions 80, 82 and 84 of the cellular model produce six regions 86, 88, 90, 92, 94, and 96. The effects with each of the regions is summarized by the air flow across the boundaries of these regions.

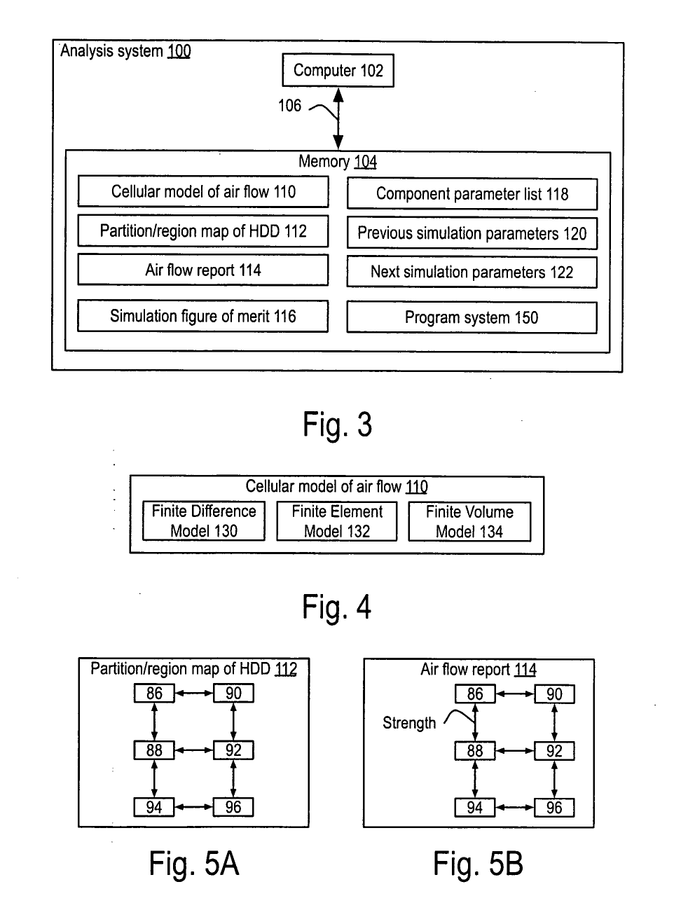

FIG. 3 shows an example embodiment of the invention including an analysis system 100. The analysis system may include at least one computer 102 accessibly coupled 106 via a bus to a computer readable memory 104. The computer readable memory may include at least one instance of the cellular model 110 of the air flow for the hard disk drive 10, a partition/region map 112 of the cellular model, an air flow report 114 generated from the cellular model and the partition/region map and a simulation figure of merit 116 derived from the air flow report. The memory may also include a component parameter list 118, the previous simulation parameters 120 and/or the next simulation parameters 122. The computer may be directed by a program system 150 including program steps residing in the memory.

The computer 102 may be directed by a program system 150 that may include program steps residing in the memory 104. As used herein, a computer may include at least one data processor and at least one instruction processor directed by the program system. Each of the data processors is at least partly instructed by at least one of the instruction processors. Various embodiments of the analysis system 100 may include more than one computer and may be referred to by some as a parallel processing computer system and/or a server farm in some embodiments of the invention.

FIG. 4 shows some details of an example of the cellular model 110 of air flow in the hard disk drive 10 and may include at least one of a finite difference model 130, a finite element model 132 and/or a finite volume model 134.

FIG. 5A shows some details of the partition/region map 112 of the hard disk drive 10 of FIGS. 2 and 3, where the arrows show the boundaries with air flow across them. FIG. 5B shows the air flow report 114 assigning numeric strengths to the arrows, indicating the air flow across those boundaries shown in FIG. 5A.

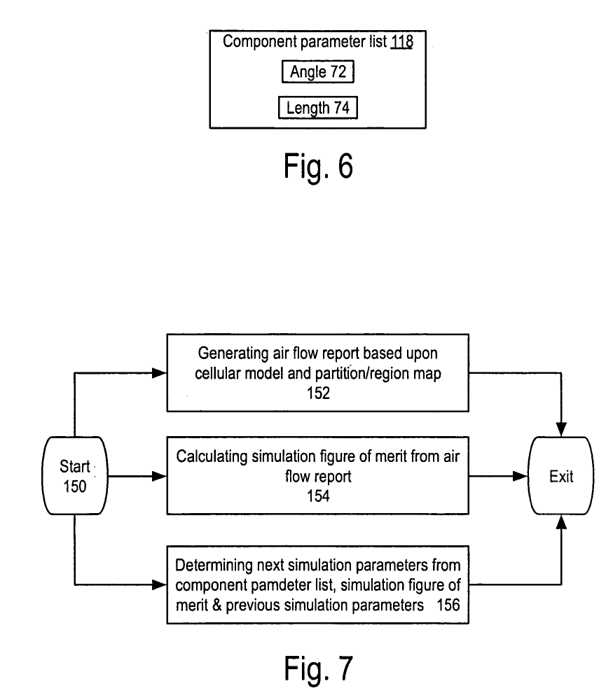

FIG. 6 shows the component parameter list 118 including by way of example, the angle 72 and length 74 of the parameterized component 70 of FIGS. 1A and 1B.

The following figure shows a flowchart of at least one embodiment of the method, which may include arrows signifying a flow of control, and sometimes data, supporting various implementations of the method. These include a program operation, or program thread, executing upon the computer. The operation of starting a flowchart refers to entering a subroutine or a macro instruction sequence in the computer. The operation of termination in a flowchart refers to completion of those operations, which may result in a subroutine return in the computer. The operation of terminating a flowchart is denoted by a rounded box with the word “Exit” in it.

FIG. 7 shows an embodiment of the program system 150 including at least one of the following program steps residing in the memory 104. Program step 152 supports generating the air flow report 114 based upon the cellular model 110 of air flow and the partition/region map 112 of the hard disk drive 10. Program step 154 supports calculating the simulation figure of merit 116 from the air flow report. Program step 156 supports determining the next simulation parameters 122 from the component parameter list 118, the simulation figure of merit 116 and the previous simulation parameters 120.

The air flow report 114, the simulation figure of merit 116, and the resulting comparison of the simulation figures of merit for varying component parameters 118 may all products of the invention's method. A prototype hard disk drive 10 including the parameterized component 70 based upon a selected component parameter list may be constructed and tested. Those tests may lead to a prototype optimization of the component parameter list that may subsequently be used to manufacture the production version of the parameterized component for assembly into a production version of the hard disk drive. The prototype hard disk drive, selected component parameter list, the prototype optimization of the component parameter list, the production version of the parameterized component, and the production version of the hard disk drive are also products of this method of using the products of the method generating the air flow report and the simulation figure of merit.

The preceding embodiments provide examples of the invention, and are not meant to constrain the scope of the following claims.

What is claimed is:

1. A method comprising the step of:
using a cellular model of air flow in a hard disk drive containing at least one parameterized component specified by a component parameter list, comprising at least one the steps of
generating an air flow report based upon said cellular model and a partition/region map of said cellular model; and
calculating a simulation figure of merit from said air flow report.

2. The method of claim 1, wherein said parameterized component includes at least one of a slider, a head gimbal assembly, a head stack assembly, at least one disk damper, at least one air baffle, at least one air duct, a disk base, a disk cover, and a disk pack including a spindle motor rotatably coupled to at least one disk.

3. The method of claim 1, wherein said cellular model includes at least one instance of at least one of a finite difference model, a finite element model, and a finite volume model.

4. The method of claim 1, further comprising the step of: determining at least one next simulation parameter from said component parameter list and said simulation figure of merit.

5. The method of claim 4, wherein the step determining said simulation parameter further comprises the step of determining said next simulation parameter from said component parameter list, said simulation figure of merit and at least one previous simulation parameter.

6. The method of claim 1, wherein said air flow report summarizes mass flow of air of said cellular model based upon said partition/region map.

7. The method of claim 6, wherein said simulation figure of merit represents an energy as derived from said air flow report in terms of said mass flow of said air.

8. A program system using a cellular model of air flow in a hard disk drive containing at least one parameterized component specified by a component parameter list and comprising program steps residing in a computer readable memory, said program system comprising at least one of the program steps of:
generating an air flow report based upon said cellular model and a partition/region map of said cellular model; and
calculating a simulation figure of merit from said air flow report.

9. The program system of claim 8, wherein said parameterized component includes at least one of a slider, a head gimbal assembly, a head stack assembly, at least one disk damper, at least one air baffle, at least one air duct, a disk base, a disk cover, and a disk pack including a spindle motor rotatably coupled to at least one disk.

10. The program system of claim 8, wherein said cellular model includes at least one instance of at least one of a finite difference model, a finite element model, and a finite volume model.

11. The program system of claim 8, further comprising the program step of: determining at least one next simulation parameter from said component parameter list and said simulation figure of merit.

12. The program system of claim 11, wherein the program step determining said simulation parameter further comprises the program step of determining said next simulation parameter from said component parameter list, said simulation figure of merit and at least one previous simulation parameter.

13. A system comprising:
at least one computer accessibly coupled to a computer readable memory and directed by a program system to use a cellular model of air flow in a hard disk drive containing at least one parameterized component specified by a component parameter list,
said program system comprising at least one of the program steps residing in said memory of:
generating an air flow report based upon said cellular model and a partition/region map of said cellular model; and
calculating a simulation figure of merit from said air flow report.

14. The system of claim 13, wherein said parameterized component includes at least one of a slider, a head gimbal assembly, a head stack assembly, at least one disk damper, at least one air baffle, at least one air duct, a disk base, a disk cover, and a disk pack including a spindle motor rotatably coupled to at least one disk.

15. The system of claim 13, wherein said cellular model includes at least one instance of at least one of a finite difference model, a finite element model, and a finite volume model.

16. The system of claim 13, wherein said program system further comprises the program step of: determining at least one next simulation parameter from said component parameter list and said simulation figure of merit.

17. The system of claim 16, wherein the program step determining said simulation parameter further comprises the program step of determining said next simulation parameter from said component parameter list, said simulation figure of merit and at least one previous simulation parameter.
